(19) United States
(12) Patent Application Publication
(10) Pub. No.: US 2014/0257920 A1
(43) Pub. Date: Sep. 11, 2014

(54) METHOD AND SYSTEM FOR OFFER TARGETING BASED ON OFFER REDEMPTION

(71) Applicant: MASTERCARD INTERNATIONAL INCORPORATED, Purchase, NY (US)

(72) Inventors: Andrea Christine Gilman, Chappaqua, NY (US); Christopher Andrew Guiney, Fenton, MO (US); Lisa Yates, Ballwin, MO (US)

(73) Assignee: MASTERCARD INTERNATIONAL INCORPORATED, Purchase, NY (US)

(21) Appl. No.: 13/793,616

(22) Filed: Mar. 11, 2013

(51) Int. Cl. G06Q 30/02

(52) U.S. Cl. CPC G06Q 30/0255
USPC 705/7.29; 705/14.53

(57) ABSTRACT

A method for distributing an offer to a consumer based on redemption history includes: storing consumer profiles, each including a consumer identifier and offer redemption data; receiving redeemed offers associated with a consumer identification, the offers associated with offer categories; identifying a specific profile, wherein the consumer identifier of the profile corresponds to the consumer identification; storing, in the offer redemption data of the specific profile, the redeemed offers; generating a behavioral profile for the specific profile based on the corresponding offer redemption data, wherein the behavioral profile includes a propensity to redeem an offer for each offer category; and transmitting an offer to a consumer associated with the specific profile, based on an offer category associated with the offer and the propensity to redeem an offer for that offer category associated with the consumer.

### FIELD

The present disclosure relates to the distribution of offers to consumers based on redemption history, specifically analyzing consumer behaviors based on previous offer redemption history to identify new offers to be distributed to the consumer.

### BACKGROUND

In order to increase revenue and obtain returning consumers, many merchants and manufacturers issue coupons, deals, and offers to consumers. The coupons may allow for savings by the consumer, while at the same time resulting in additional revenue to the merchant both as a result of the purchase and in instances where the consumer may purchase additional items separate from the coupon or deal.

In order to increase the redemption rate of offers, which would in turn likely increase revenue, some merchants and offer providers use a variety of criteria in order to determine which offers should be distributed to which consumers. Merchants and offer providers may look at demographic information for consumers and distribute offers accordingly. For example, a merchant may distribute an offer for sporting equipment to a male, while distributing an offer for cosmetics to a female. In some instances, merchants may utilize transaction history, either anonymous or with the consent of a consumer, for use in the distribution of offers. For example, an electronics store may identify consumers that regularly spend in electronics and distribute related offers to those consumers in particular.

However, while merchants and offer providers may target consumers more likely to spend at a specific retailer or on a specific product, the consumers themselves may not be influenced by an offer or may choose not to redeem an offer once received. For example, a consumer may have a routine and not be influenced to change that routine upon the receipt of an offer. Thus, there is a need for a technical solution to improve the distribution of offers to consumers in an effort to achieve a higher rate of redemption.

### SUMMARY

The present disclosure provides a description of a systems and methods for the distribution of offers and offer profiles based on redemption history and a system and method for the fulfillment of a request for offer profiles.

A method for distributing an offer to a consumer based on redemption history includes: storing, in a consumer database, a plurality of consumer profiles, wherein each consumer profile is associated with a consumer and includes at least a consumer identifier and offer redemption data; receiving, by a receiving device, a plurality of redeemed offers associated with a consumer identification, wherein the plurality of redeemed offers are associated with a plurality of offer categories; identifying, by a processing device, a specified consumer profile, wherein the consumer identifier of the specified consumer profile corresponds to the consumer identification; storing, in the offer redemption data of the specified consumer profile, the received plurality of redeemed offers; generating, by the processing device, a behavioral profile for the specified consumer profile based on the corresponding offer redemption data, wherein the behavioral profile includes at least a propensity to redeem an offer for each offer category of the plurality of offer categories; and transmitting, by a transmitting device, an offer to a consumer associated with the specified consumer profile, based on a specific offer category associated with the offer and the propensity to redeem an offer for the specific offer category of the consumer associated with the specified consumer profile.

A method for distributing an offer profile based on redemption history includes: storing, in a consumer database, a plurality of consumer profiles, wherein each consumer profile is associated with a consumer and includes at least a consumer identifier and offer redemption data, wherein the offer redemption data includes a plurality of offers redeemed by the associated consumer, the plurality of offers associated with a plurality of offer categories; receiving, by a receiving device, a request for a behavioral profile, wherein the request for a behavioral profile includes at least a consumer identification and at least one offer category; identifying, by a processing device, a specified consumer profile, wherein the consumer identifier of the specified consumer profile corresponds to the consumer identification; generating, by the processing device, a behavioral profile for the specified consumer profile based on the corresponding offer redemption data, wherein the behavioral profile includes a propensity to redeem an offer for each offer category of the at least one offer category; and transmitting, by a transmitting device, the generated behavioral profile in response to the request for a behavioral profile.

A method for fulfilling a request for behavioral profiles includes: storing, in a consumer database, a plurality of consumer profiles, wherein each consumer profile is associated with a consumer and includes at least a consumer identifier and offer redemption data, wherein the offer redemption data includes a plurality of offers redeemed by the associated consumer, the plurality of offers associated with a plurality of offer categories; receiving, by a receiving device, a request for behavioral profiles, wherein the request for behavioral profiles includes a specified offer category and a propensity to redeem threshold; generating, by a processing device, a behavioral profile for each consumer profile of the plurality of consumer profiles based on the corresponding offer redemption data, wherein the behavioral profile includes at least a propensity to redeem an offer for the specified offer category; identifying, by the processing device, at least one behavioral profile, wherein the included propensity to redeem an offer for the specified offer category exceeds the propensity to redeem threshold; and transmitting, by a transmitting device, the identified at least one behavioral profile in response to the request for behavioral profiles.

A system for distributing an offer to a consumer based on redemption history includes a consumer database, a receiving device, a processing device, and a transmitting device. The consumer database is configured to store a plurality of consumer profiles, wherein each consumer profile is associated with a consumer 102 and includes at least a consumer identifier and offer redemption data. The receiving device is configured to receive a plurality of redeemed offers associated with a consumer identification, wherein the plurality of redeemed offers are associated with a plurality of offer categories. The processing device is configured to: identify a specified consumer profile, wherein the consumer identifier of the specified consumer profile corresponds to the consumer identification; store, in the offer redemption data of the specified consumer profile, the received plurality of redeemed offers; and generate a behavioral profile for the specified consumer profile based on the corresponding offer redemption data, wherein the behavioral profile includes at least a propensity to redeem an offer for each offer category of the plurality of offer categories. The transmitting device is configured to transmit an offer to a consumer associated with the specified consumer profile, based on a specific offer category associated with the offer and the propensity to redeem an offer for the specific offer category of the consumer associated with the specified consumer profile.

A system for distributing an offer profile based on redemption history includes a consumer database, a receiving device, a processing device, and a transmitting device. The consumer database is configured to store a plurality of consumer profiles, wherein each consumer profile is associated with a consumer and includes at least a consumer identifier and offer redemption data, wherein the offer redemption data includes a plurality of offers redeemed by the associated consumer, the plurality of offers associated with a plurality of offer categories. The receiving device is configured to receive a request for a behavioral profile, wherein the request for a behavioral profile includes at least a consumer identification and at least one offer category. The processing device is configured to identify a specified consumer profile, wherein the consumer identifier of the specified consumer profile corresponds to the consumer identification and generate, a behavioral profile for the specified consumer profile based on the corresponding offer redemption data, wherein the behavioral profile includes a propensity to redeem an offer for each offer category of the at least one offer category. The transmitting device is configured to transmit the generated behavioral profile in response to the request for a behavioral profile.

A system for fulfilling a request for behavioral profiles includes a consumer database, a receiving device, a processing device, and a transmitting device. The consumer database is configured to store a plurality of consumer profiles, wherein each consumer profile is associated with a consumer and includes at least a consumer identifier and offer redemption data, wherein the offer redemption data includes a plurality of offers redeemed by the associated consumer, the plurality of offers associated with a plurality of offer categories. The receiving device is configured to receive a request for behavioral profiles, wherein the request for behavioral profiles includes a specified offer category and a propensity to redeem threshold. The processing device is configured to: generate a behavioral profile for each consumer profile of the plurality of consumer profiles based on the corresponding offer redemption data, wherein the behavioral profile includes at least a propensity to redeem an offer for the specified offer category; and identify at least one behavioral profile, wherein the included propensity to redeem an offer for the specified offer category exceeds the propensity to redeem threshold. The transmitting device is configured to transmit the identified at least one behavioral profile in response to the request for behavioral profiles.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a high level architecture illustrating a system for distribution of offers based on redemption history in accordance with exemplary embodiments.

FIG. 2 is a diagram illustrating a processing server for use in the system of FIG. 1 in accordance with exemplary embodiments.

FIG. 3 is a diagram illustrating a consumer database of the processing server of FIG. 2 in accordance with exemplary embodiments.

FIG. 4 is a diagram illustrating an offer database of the processing server of FIG. 2 in accordance with exemplary embodiments.

FIG. 5 is a processing flow illustrating a method for the distribution of offers based on redemption history in accordance with exemplary embodiments.

FIG. 6 is a processing flow illustrating a method for the distribution of a consumer profile based on redemption history in accordance with exemplary embodiments.

FIG. 7 is a flow chart illustrating an exemplary method for distributing an offer to a consumer based on redemption history in accordance with exemplary embodiments.

FIG. 8 is a flow chart illustrating an exemplary method for distributing an offer profile based on redemption history in accordance with exemplary embodiments.

FIG. 9 is a flow chart illustrating an exemplary method for fulfilling a request for behavioral profiles in accordance with exemplary embodiments.

FIG. 10 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Definition of Terms

Offer—A discount available to a consumer for the purchase, exchange, etc. for goods, services, products, etc. As used herein, offer may be considered synonymous with discount, deal, coupon, or any other term used to indicate that a discount available to a consumer. An offer may be issued by a merchant, retailer, manufacturer, offer or deal provider, payment card issuer, or any other entity that may issue offers to consumers. An offer may be a physical offer or coupon (e.g., in a printed form that may be carried by the consumer) or a virtual offer or coupon, which may be stored in an electronic device (e.g., a server database, a smart phone) and applied to a transaction (e.g., via presentation to a merchant, automatic application to the transaction by association with a payment account of the consumer, automatic application to the transaction by the merchant, etc.).

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, financial accounts, etc. Examples of networks or systems configured to perform as payment networks include those operated by MasterCard® and VISA®.

### System for Distributing Offers and Profiles Based on Redemption History

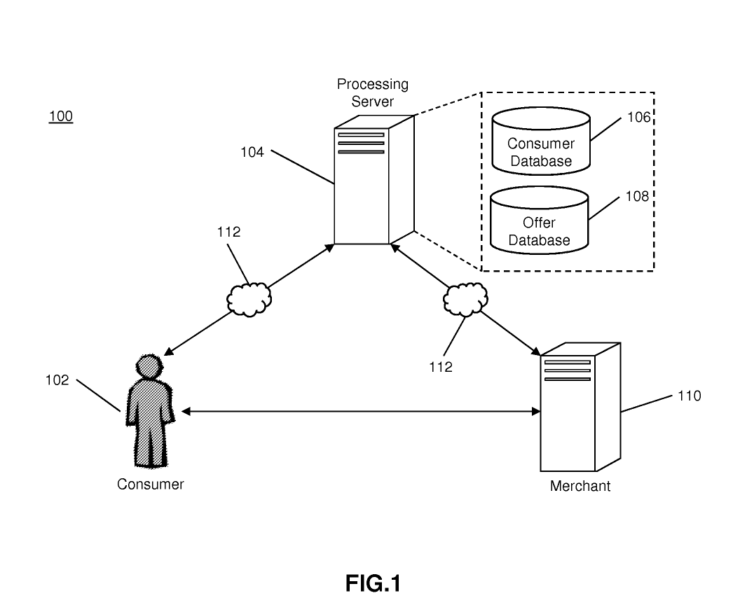

FIG. 1 is a high level architecture illustrating a system 100 for distributing offers and offer profiles based on redemption history.

The system 100 may include a consumer 102, a processing server 104, and a merchant 110. Each of the components may be configured to communicate (e.g., directly, or via a communication device such as a cellular phone, smart phone, computer, etc.) via a network 112. The network 112 may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art.

The processing server 104, discussed in more detail below, may be any type of server configured to perform the functions as disclosed herein. The processing server 104 may perform as or be a part of a payment network used to process financial transactions. Methods suitable for processing financial transactions will be apparent to persons having skill in the relevant art. The processing server 104 may process a financial transaction involving the consumer 102 and the merchant 112 where the consumer 102 may redeem an offer as part of the financial transaction.

As discussed in more detail below, the processing server 104 may store data related to the redemption of the offer by the consumer 102 in a consumer database 106. In some embodiments, the consumer 102 may be required to register for an offer service with the processing server 104, such as by visiting a webpage hosted by or on behalf of the processing server 104 or using an application program on a mobile communication device (e.g., a cellular phone, a smart phone, a tablet computer, etc.). In other embodiments, the consumer 102 may be required to opt-in to the service. In an exemplary embodiment, data stored in the consumer database 106, discussed in more detail below, may be kept anonymous such that the processing server 104 may not possess any personally identifiable information of the consumer 102.

The processing server 104 may generate behavioral profiles for consumers based on their offer redemption history stored in the consumer database 106. In some embodiments, the processing server 104 may transmit consumer profiles to a third party, such as an offer provider, for the distribution of offers to the consumer 102 based on the consumer's redemption history. The consumer profiles may be grouped together or may have potential personally identifiable information removed or encrypted such as to prohibit the processing server 104 or third party from identifying an individual consumer 102. In some instances, the processing server 104 or third party responsible for distributing offers to the consumer 102 may seek consent from the consumer 102 for the use of potential personally identifiable information to identify the consumer's personal redemption history for the distribution of offers ideally suitable for that consumer.

In other embodiments, the processing server 104 may include an offer database 108, discussed in more detail below, configured to store data related to a plurality of offers available for distribution to consumers. The processing server 104 may (e.g., using methods discussed in more detail below) distribute offers to consumers based on specific criteria related to each consumer (e.g., the consumer 102), including their redemption history stored in the consumer database 106. Additional criteria may include transaction history, demographic information, etc. In some embodiments, criteria for the distribution of an offer may be specified by the offer originator.

### Processing Server

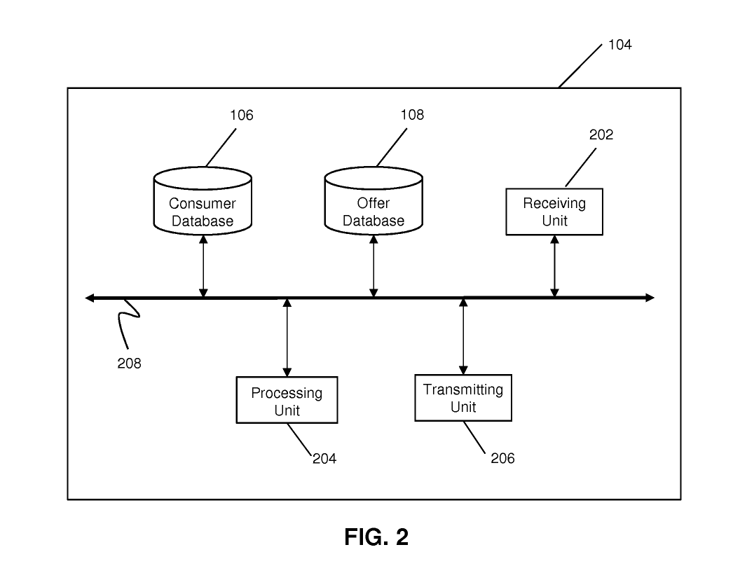

FIG. 2 illustrates an embodiment of the processing server 104 for use in the system 100. It will be apparent to persons having skill in the relevant art that the embodiment of the processing server 104 illustrated in FIG. 2 is provided as illustration only and may not be exhaustive to all possible configurations of the processing server 104 suitable for performing the functions as discussed herein. For example, the computer system 1000 illustrated in FIG. 1 and discussed in more detail below may be a suitable configuration of the processing server 104.

The processing server 104 may include the consumer database 106, the offer database 108, a receiving unit 202, a processing unit 204, and a transmitting unit 206. Each of the components may be configured to communicate via a bus 208. Suitable types and configurations for the bus 208 will be apparent to persons having skill in the relevant art. Additional components or configurations of the processing server 104 will also be apparent to persons having skill in the relevant art.

The consumer database 106, discussed in more detail below, may be configured to store data related to a plurality of consumers (e.g., including the consumer 102). In an exemplary embodiment, the data stored in the consumer database 106 may not include any personally identifiable information. In another embodiment, the consumer database 106 may include potentially personally identifiable information only with the expressed consent of each corresponding consumer. Methods for storing consumer data without obtaining or including personally identifiable information will be apparent to persons having skill in the relevant art.

The offer database 108, discussed in more detail below, may be configured to store data related to a plurality of offers. The receiving unit 202 may be configured to receive offer information from a third party, such as the originator of the offer (e.g., the merchant 110, an offer provider, a product manufacturer, etc.). The processing unit 204 may store the received offer information as an entry in the offer database 108. The offer information may include at least information used for identifying the offer, determining availability, and conditions for redemption, as discussed in more detail below.

In embodiments where the consumer 102 may be required to register for an offer distribution service (e.g., provided by the processing server 104 or a third party offer provider), the receiving unit 202 may be configured to receive consumer information from the consumer 102. The processing unit 204 may store the consumer information in a data entry related to the consumer 102 in the consumer database 106, discussed in more detail below.

The receiving unit 202 may also be configured to receive an authorization request for a financial transaction involving the consumer 102. Authorization requests may be received using protocols and methods apparent to persons having skill in the relevant art. The authorization request may indicate that an offer is being redeemed as part of the financial transaction. The processing unit 204 may process the financial transaction and redemption of the offer using methods apparent to persons having skill in the relevant art. The processing unit 204 may submit an authorization response as part of the transaction processing to the originator of the authorization request (e.g., the merchant 110). In some embodiments, the processing server 104 may be part of a payment network but may not be configured to process financial transactions. In such an embodiment, the receiving unit 202 may alternatively receive information regarding the redemption of the offer as part of the financial transaction.

The processing unit 204 may be configured to store in the entry related to the consumer 102 in the consumer database 106 data regarding the offer redeemed in the financial transaction. In some embodiments, the processing unit 204 may then update a behavioral profile associated with the consumer 102 based on the redeemed offer. In other embodiments, the processing unit 204 may not update the behavioral profile until prompted (e.g., by the consumer 102, upon the receipt of a request for consumer profiles, at a predetermined time, etc.).

In embodiments where the processing server 104 may be configured to distribute offers to consumers, the processing unit 204 may analyze consumer profiles in the consumer database 106 and identify suitable offers in the offer database 108, as discussed in more detail below. The transmitting unit 206 may be configured to transmit, to the consumer 102 (e.g., or to a device associated with the consumer 102) the identified suitable offers. In some embodiments, the consumer 102 may specify a preferred method of distribution for the offers, which the processing unit 204 may store in the corresponding entry in the consumer database 106. Methods for distribution for offers will be apparent to persons having skill in the relevant art and may include traditional mail, e-mail, short message service (SMS) message, multimedia message service (MMS) message, an application program on a communication device, or via at least one social network.

In some instances, the receiving unit 202 may receive a request for a consumer profile, such as from the merchant 110 or an offer provider. In an exemplary embodiment, the request may not include any personally identifiable information. In an alternative embodiment, the request may include personally identifiable information upon express consent provided by the corresponding consumer. The processing unit 204 may identify the request consumer profile in the consumer database 106, and the transmitting unit 206 may transmit the identified profile as a response to the request.

In one embodiment, the receiving unit 202 may receive a request to provide consumer profiles based on specified criteria, discussed in more detail below. The processing unit 204 may identify a plurality profiles in the consumer database 106 that meet or exceed the specified criteria included in the request. The transmitting unit 206 may then transmit the profiles in response to the request. In such an embodiment, an offer provider may specify that they desire to distribute offers to consumers with a history of redeeming offers for electronics. The processing unit 204 may then identify those consumers whose profiles indicate a propensity to redeem electronics offers, and provide those profiles and/or consumer information (e.g., either non-personally identifiable or at the consent of the corresponding consumer) to the offer provider. The offer provider may the use the information to distribute offers to those consumers, which may result in a higher than average redemption rate.

### Consumer & Offer Databases

Data stored in the consumer database 106 and the offer database 108 (the “databases”) may be stored on any type of suitable computer readable media, such as optical storage (e.g., a compact disc, digital versatile disc, Blu-ray disc, etc.) or magnetic tape storage (e.g., a hard disk drive). The databases may be configured in any type of suitable database configuration, such as a relational database, a structured query language (SQL) database, a distributed database, an object database, etc. Suitable configurations and database storage types will be apparent to persons having skill in the relevant art. The databases may each be a single database, or may comprise multiple databases which may be interfaced together (e.g., physically or via a network, such as the network 112).

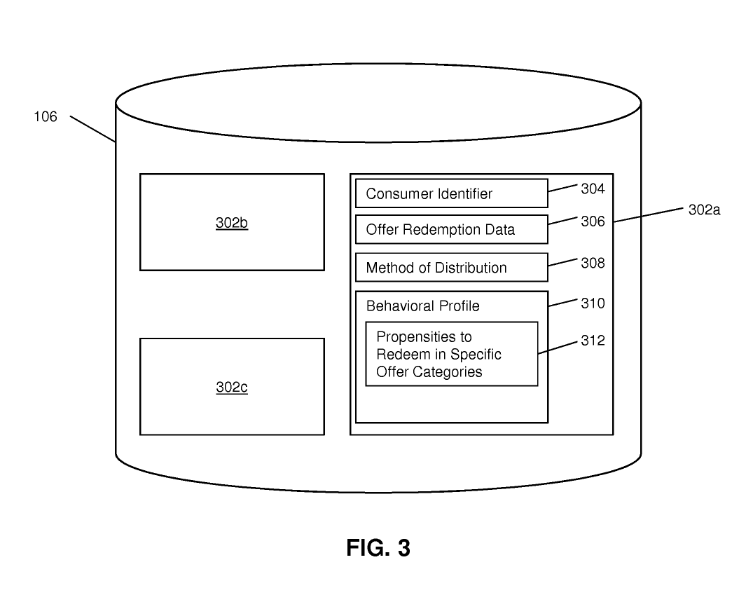

FIG. 3 illustrates a diagram of the consumer database 106. The consumer database 106 may store a plurality of consumer data entries 302, illustrated in FIG. 3 as consumer data entries 302a, 302b, and 302c. Each consumer data entry 302 may store data related to a consumer (e.g., the consumer 102). The data stored in each consumer data entry 302 may include a consumer identifier 304, offer redemption data 306, a method of distribution 308, and a behavioral profile 310.

The consumer identifier 304 may be a value unique to the consumer data entry 302 used to identify the consumer data entry 302. Values suitable for use as the consumer identifier 304 will be apparent to persons having skill in the relevant art and may include an account number, a username, a phone number, an e-mail address, a serial number, etc. In some embodiments, the consumer data entry 302 may include additional authentication information, which in some instances may be used in addition to the consumer identifier 304, such as a password used in addition to a username that acts as the consumer identifier 304 to authenticate the consumer 102 to allow the consumer 102 to modify their profile (e.g., to change their method of distribution 308).

The offer redemption data 306 may include data related to offers redeemed by the corresponding consumer 102. The data related to redeemed offers stored in the offer redemption data 306 may include data similar to that stored in offers included in the offer database 108, discussed below. The data may include, for example, the offer originator, industry category, merchant category, offer type, offer value, redemption date, or other data suitable for analysis for generating the behavioral profile 310 of the consumer 102.

The method of distribution 308 may be the preferred method and/or corresponding details for the distribution of offers to the consumer 102. Methods of distribution 308 may include traditional mail, e-mail, SMS message, MMS message, application programs, and social networks. In some embodiments, the consumer 102 may specify multiple methods of distribution, such as having offers distributed via an application program on a mobile communication device and also receiving a notification of the offer via SMS message.

The behavioral profile 310 may be a profile identified (e.g., generated) by the processing unit 204 of the processing server 104. The behavioral profile 310 may include propensities to redeem 312, which may indicate the propensity for the corresponding consumer 102 to redeem an offer of specific offer categories. Offer categories that may be used to identify propensities to redeem 312 may include specific merchants (e.g., the merchant 110), merchant industry (e.g., electronics, sporting goods, cosmetics, hardware, etc.), offer type (e.g., percentage discount, number discount, buy one get one free, etc.), offer value (e.g., $10, $25, $50, etc.), minimum transaction amount (e.g., none, $50, $100, etc.), or other categories that will be apparent to persons having skill in the relevant art. The processing unit 204 may identify propensities to redeem 312 for each category based on the offer redemption data 306. In some embodiments, the processing unit 204 may only identify those propensities 312 relevant to a particular offer or request for profiles. Additional information that the behavioral profile 310 may include or be based on may include transaction data, demographic data, user preferences, etc.

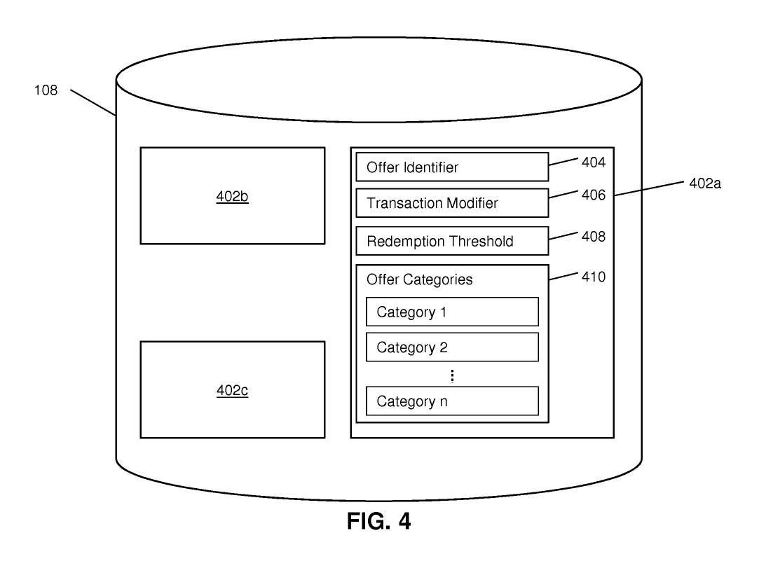

FIG. 4 illustrates a diagram of the offer database 108. The offer database 108 may include a plurality of offer data entries 402, illustrated in FIG. 4 as offer data entries 402a, 402b, and 402c. Each offer data entry 402 may be configured to store data related to an offer and may include an offer identifier 404, a transaction modifier 406, a redemption threshold 408, and offer categories 410.

The offer identifier 404 may be a value unique to the offer suitable for use in identifying the offer, such as for identification for processing redemption of the offer during the processing of a financial transaction. The offer identifier 404 may be any type of value suitable for identifying the offer including a universal product code (UPC), European article number (EAN), stock-keeping unit (SKU), manufacturer part number (MPN), serial number, etc.

The transaction modifier 406 may indicate how a financial transaction is to be modified as a result of redemption of the corresponding offer. For example, the transaction modifier 406 may indicate that the offer is to reduce the transaction amount for the financial transaction by $10 or by 25%, or that a specific product (e.g., identifying using a product identifier) is to be free for the transaction. Data suitable for use as and methods suitable for representation of the transaction modifier 406 will be apparent to persons having skill in the relevant art.

The redemption threshold 408 may be a value that indicates a threshold at which the corresponding offer may be distributed to a consumer, such as based on the consumer's behavioral profile 310 or at least one propensity to redeem 312. For example, the redemption threshold 408 may indicate that the corresponding offer is to be distributed to those consumers with a specific propensity to redeem offers for electronics. The processing unit 204 may identify those consumer data entries 302 in the consumer database 106 whose behavioral profile 310 include a propensity to redeem offers for electronics that meet or exceed the redemption threshold 408. The transmitting unit 206 may then distribute the offer to the corresponding consumers (e.g., by their methods of distribution 308).

The offer categories 410 may include at least one category to which the offer belongs. Offer categories may include a particular merchant, a particular manufacturer, minimum transaction amount, offer value, offer type, a particular industry, offer quantity, redemption limitations, length of availability, etc. For example, an offer for $10 off a purchase of $50 or more at the merchant 110 may have offer categories in the offer categories 410 in the corresponding offer data entry 402 including the offers at merchant 110, flat amount offers, offers valued at $10, and offers with a minimum transaction amount of $50. The offer categories 410 may also include industry categories for any industries associated with the products offer by the merchant 110 for which the offer may be used.

Each offer data entry 402 may include additional information related to the corresponding offer as will be apparent to persons having skill in the relevant art. For example, the offer data entry 402 may further include a minimum transaction amount (e.g., amount that must be met for the offer to be eligible for redemption), a quantity (e.g., number of times the offer may be redeemed), an offer name, an offer image, an offer description, a listing of eligible merchants, an offer originator, terms and conditions, limitations on redemption, transferability guidelines, etc. In some instances, data included in each offer data entry 402 may vary depending on the offer, type of offer, offer originator, etc.

### Processing Flow for the Distribution of Offers Based on Redemption History

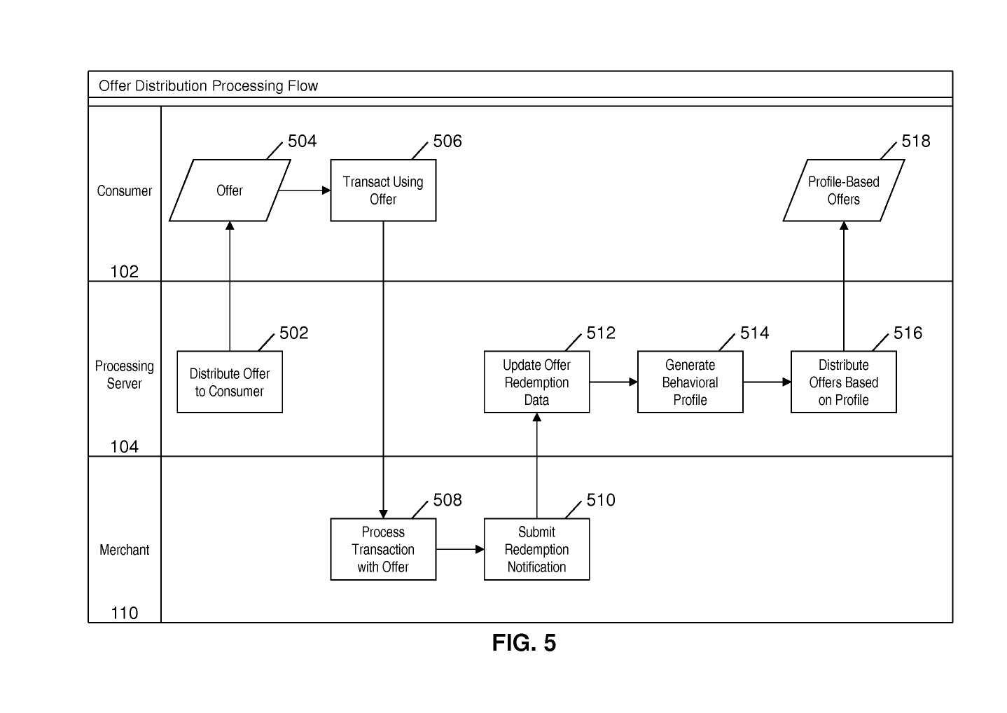

FIG. 5 illustrates a processing flow for a method for distributing offers to a consumer (e.g., the consumer 102) based on redemption history.

In step 502, the processing server 104, or a third party such as an offer provider, may distribute an offer to the consumer 102. The offer may be distributed to the consumer 102 via a preferred method of distribution 308. In some instances, the offer may be transmitted to a communication device associated with the consumer 102 (e.g., via the network 112). In other instances, notification of the offer may be transmitted to the consumer 102 and the offer may be associated with a financial account of the consumer 102.

In step 504, the consumer 102 may receive (e.g., personally or via a communication device) the offer or notification of the offer. In step 506, the consumer 102 may transact with the merchant 110 using the received offer. The merchant 110 may, in step 508, process the financial transaction including the offer presented by the consumer 102. In some embodiments, the financial transaction may be processed by the processing server 104 or by a payment network including the processing server 104. In such an embodiment, the processing server 104 may determine the eligibility of the offer for redemption and may therefore be notified by itself or the payment network if the offer was successfully redeemed. In other embodiments, the merchant 110 may submit a notification of redemption of the offer to the processing server 104 in step 510. The notification may include at least information identifying the consumer 102 (e.g., the consumer identifier 304) and information identifying the redeemed offer (e.g., the offer identifier 404).

In step 512, the processing server 104 may identify the consumer data entry 302 corresponding to the consumer 102 (e.g., based on the consumer identifier 304) and may update the related offer redemption data 306. The processing server 514 may then generate an updated behavioral profile 310 based on the updated offer redemption data 306 for the consumer, including updating propensities to redeem 312 for categories corresponding to those offer categories included in the offer categories 410 of the redeemed offer. The processing server 104 may then identify offers in the offer database 108 where the associated redemption thresholds 408 are met and/or exceeded by the corresponding propensities to redeem 312 by the consumer 102.

The processing server 104 may then, in step 516, transmit the identified offers that are based on the redemption history of the consumer 102 to the consumer 102 via the consumer's preferred method of distribution 308. The consumer 102 may receive the offers in step 518, and then use the offers when conducting further transactions, which may then also be taken into account in the consumer's offer redemption data 306 and used to develop the consumer's behavioral profile 310.

### Processing Flow for Distributing Consumer Profiles Based on Redemption History

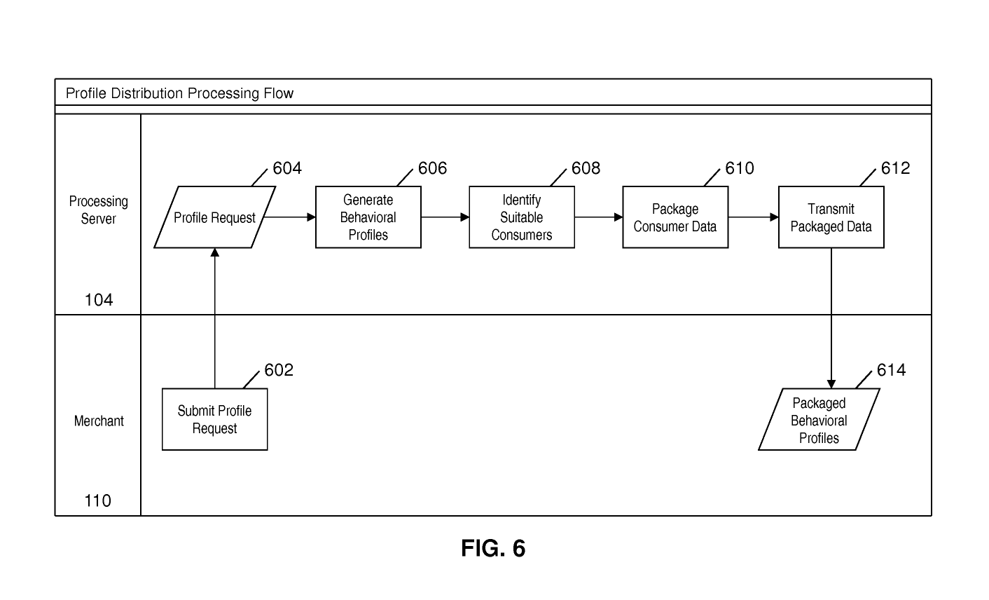

FIG. 6 illustrates a processing flow for a method for the distributing of consumer profiles based on redemption history in response to a profile request.

In step 602, the merchant 110 may submit a profile request to the processing server 104. The processing server 104 may then receive the profile request 604 and identify data included in the profile request. The profile request may include at least one specified offer category and a propensity to redeem threshold for each specified offer category. In step 606, the processing server 104 may generate behavioral profiles 310 for each consumer data entry 302 based on the offer redemption data 306 included in the consumer data entry 302, where the generated behavioral profiles 310 include a propensity to redeem 312 for each of the at least one specified offer category.

In step 608, the processing server 104 may identify suitable consumers that fit the profile request where the propensity to redeem 312 for each of the at least one specified offer category meets or exceeds the propensity to redeem threshold associated with that category. In some embodiments, the processing server 104 may further identify suitable consumers based on additional information included in the related consumer data entry 302, such as user preferences regarding the receipt and notification of new offers.

In step 610, the processing server 104 may package the relevant consumer data. The packaging of the consumer data may include the encryption or removal of data necessary to ensure the anonymity of consumers and/or prevent the processing server 104 from possessing any type of personally identifiable information. Then, in step 612, the processing server 104 may transmit the packaged data to the merchant 110. The merchant 110 may receive the packaged data identifying the consumers in step 614, which the merchant 110 may then use for the distribution of offers or advertising to consumers with a demonstrated propensity to redeem offers in the requested categories.

### Exemplary Method for Distributing an Offer to a Consumer Based on Redemption History

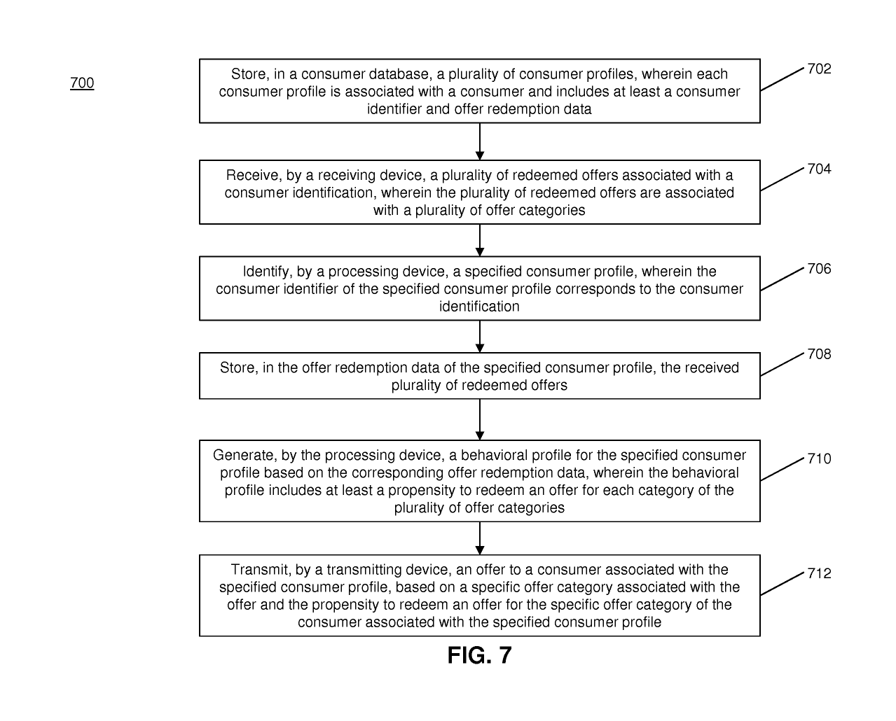

FIG. 7 illustrates an exemplary method 700 for distributing an offer to a consumer based on redemption history.

In step 702, a plurality of consumer profiles (e.g., consumer data entries 302) may be stored in a consumer database (e.g., the consumer database 106), wherein each consumer profile 302 is associated with a consumer (e.g., the consumer 102) and includes at least a consumer identifier (e.g., the consumer identifier 304) and offer redemption data (e.g., the offer redemption data 306). In step 704, a receiving device (e.g., the receiving unit 202) may receive a plurality of redeemed offers associated with a consumer identification, wherein the plurality of redeemed offers are associated with a plurality of offer categories. In one embodiment the plurality of offer categories may include at least one of: a particular merchant, a particular manufacturer, a transaction amount, an offer amount, a particular industry, an offer type, an offer quantity, and a length of availability.

In step 706, a processing device (e.g., the processing unit 204), may identify a specified consumer profile, wherein the consumer identifier 304 of the specified consumer profiles corresponds to the consumer identification. In step 708, the received plurality of redeemed offers may be stored in the offer redemption data 306 of the specified consumer profile. In step 710, the processing device 204 may generate a behavioral profile (e.g., the behavioral profile 310) for the specified consumer profile based on the corresponding offer redemption data 306, wherein the behavioral profile 310 includes at least a propensity to redeem and offer (e.g., the propensity to redeem 312) for each category in the plurality of offer categories.

In step 712, a transmitting device (e.g., the transmitting device 206) may transmit an offer to a consumer associated with the specified consumer profile, based on a specific offer category associated with the other and the propensity to redeem an offer 312 for the specific offer category of the consumer associated with the specified consumer profile. In some embodiments, the offer transmitted to the consumer associated with the specified consumer profile may include a propensity to redeem threshold (e.g., the redemption threshold 408), and the propensity to redeem an offer 312 for the specific offer category may exceed the propensity to redeem threshold 408 for transmission of the offer to the consumer. In one embodiment, each consumer profile 302 may further include a method of distribution (e.g., the method of distribution 308) and transmitting an offer to the consumer associated with the specified consumer profile may include transmitting the offer to the consumer via the method of distribution 308 included in the specified consumer profile.

### Exemplary Method for Distributing an Offer Profile Based on Redemption History

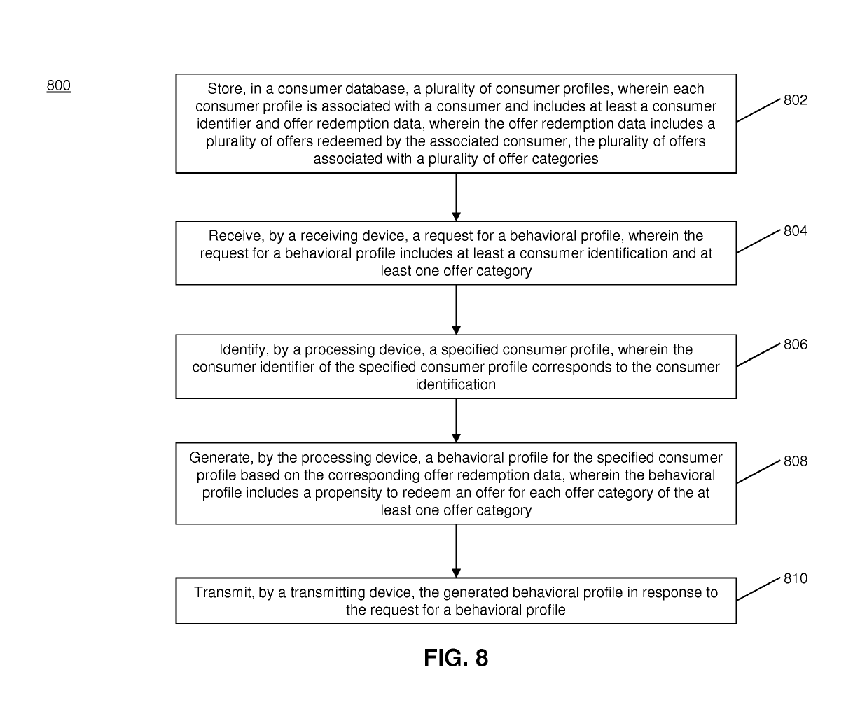

FIG. 8 illustrates a method 800 for the distributing of an offer profile associated with a consumer based on the consumer's redemption history. In such a method, an offer provider (e.g., the merchant 110) may identify a consumer (e.g., the consumer 102) for the distribution of offers, but may request a profile (e.g., at the consumer's request and/or with the consumer's consent) for the consumer 102 to determine what offers to distribute to the consumer 102. For example, the consumer 102 may register with a loyalty program at a merchant 110, and the merchant 110 may desire the consumer's profile to identify the types of offers most commonly redeemed by the consumer 102 for the distribution of better offers as part of the program.

In step 802, a plurality of consumer profiles (e.g., consumer data entries 302) may be stored in a consumer database (e.g., the consumer database 106), wherein each consumer profile 302 is associated with a consumer (e.g., the consumer 102) and includes at least a consumer identifier (e.g., the consumer identifier 304) and offer redemption data (e.g., the offer redemption data 306), wherein the offer redemption data 306 includes a plurality of offers redeemed by the associated consumer 102, the plurality of offers associated with a plurality of offer categories. In an exemplary embodiment, the consumer profiles 302 do not include any personally identifiable information. In one embodiment, the plurality of offer categories may include at least one of: a particular merchant, a particular manufacturer, a transaction amount, an offer amount, a particular industry, an offer type, an offer quantity, and a length of availability.

In step 804, a receiving device (e.g., the receiving unit 202) may receive a request for a behavioral profile, wherein the request for a behavioral profile includes at least a consumer identification and at least one offer category. In an exemplary embodiment, the request for a behavioral profile may not include any personally identifiable information and the consumer identification may not be potentially personally identifiable. In step 806, a processing device (e.g., the processing unit 204) may identify a specified consumer profile, wherein the consumer identifier 304 for the specified consumer profile corresponds to the consumer identification.

In step 808, the processing device 204 may generate a behavioral profile (e.g., the behavioral profile 310) for the specified consumer profile based on the corresponding offer redemption data 306, wherein the behavioral profile 310 includes a propensity to redeem an offer (e.g., propensity to redeem 312) for each offer category of the at least one offer category. In an exemplary embodiment, the generated behavioral profile 310 may not be personally identifiable. In step 810, a transmitting device (e.g., the transmitting unit 206) may transmit the generated behavioral profile 310 in response to the request for a behavioral profile.

### Exemplary Method for Fulfilling a Request for Behavioral Profiles

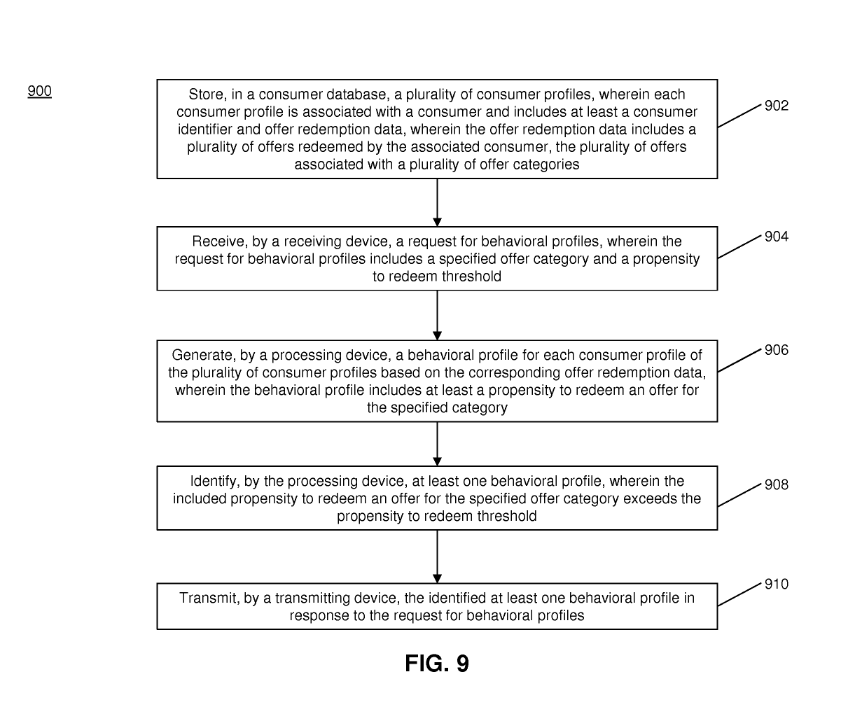

FIG. 9 illustrates a method 900 for fulfilling a request for behavioral profiles. In such a method, an offer provider may want to distribute an offer or a group of offers to consumers having a tendency to redeem similar offers, in an effort to have an increase rate of redemption of distributed offers. The offer provider may obtain profiles for a plurality of consumers that match supplied criteria, who may be distributed the offer or group of offers accordingly.

In step 902, a plurality of consumer profiles (e.g., the consumer data entries 302) may be stored in a consumer database (e.g., the consumer database 106), wherein each consumer profile 302 is associated with a consumer (e.g., the consumer 102) and includes at least a consumer identifier (e.g., the consumer identifier 304), and offer redemption data (e.g., the offer redemption data 306), wherein the offer redemption data 306 includes a plurality of offers redeemed by the associated consumer 102, the plurality of offers associated with a plurality of offer categories. In an exemplary embodiment, each consumer profile 302 may include no personally identifiable information. In one embodiment, the plurality of offer categories may include at least one of: a particular merchant, a particular manufacturer, a transaction amount, an offer amount, a particular industry, an offer type, an offer quantity, and a length of availability.

In step 904, a receiving device (e.g., the receiving unit 202) may receive a request for behavioral profiles, wherein the request for behavioral profiles includes a specified offer category and a propensity to redeem threshold. In step 906, a processing device (e.g., the processing unit 204) may generate a behavioral profile (e.g., the behavioral profile 310) for each consumer profile 302 of the plurality of consumer profiles based on the corresponding offer redemption data 306, wherein the behavioral profile 310 includes at least a propensity to redeem an offer (e.g., the propensity to redeem 312) for the specified category. In an exemplary embodiment, the generated behavioral profile 310 may include no personally identifiable information.

In step 908, the processing device 204 may identify at least one behavioral profile 310 where the included propensity to redeem an offer 312 for the specified offer category exceeds the propensity to redeem threshold. In step 910, a transmitting device (e.g., the transmitting unit 206) may transmit the identified at least one behavioral profile 310 in response to the request for behavioral profiles. In some embodiments, the transmitting device 206 may transmit only those behavioral profiles 310 that correspond to consumers who provide express consent to the release of their information.

### Computer System Architecture

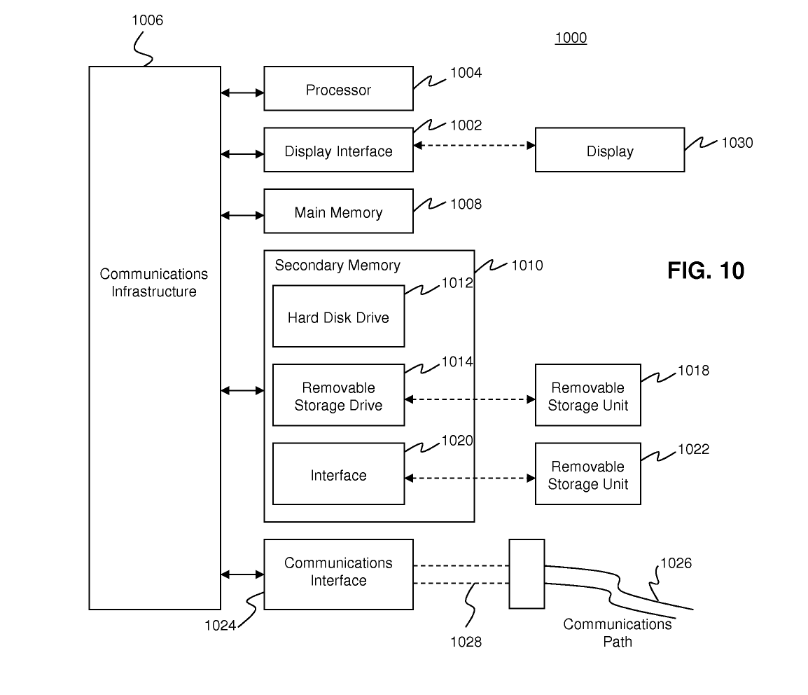

FIG. 10 illustrates a computer system 1000 in which embodiments of the present disclosure, or portions thereof, may be implemented as computer-readable code. For example, the processing server 104 and merchant 110 of FIG. 1 may be implemented in the computer system 1000 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 5-9.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 1018, a removable storage unit 1022, and a hard disk installed in hard disk drive 1012.

Various embodiments of the present disclosure are described in terms of this example computer system 1000. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 1004 may be a special purpose or a general purpose processor device. The processor device 1004 may be connected to a communication infrastructure 1006, such as a bus, message queue, network (e.g., the network 112), multi-core message-passing scheme, etc. The computer system 1000 may also include a main memory 1008 (e.g., random access memory, read-only memory, etc.), and may also include a secondary memory 1010. The secondary memory 1010 may include the hard disk drive 1012 and a removable storage drive 1014, such as a floppy disk drive, a magnetic tape drive, an optical disk drive, a flash memory, etc.

The removable storage drive 1014 may read from and/or write to the removable storage unit 1018 in a well-known manner. The removable storage unit 1018 may include a removable storage media that may be read by and written to by the removable storage drive 1014. For example, if the removable storage drive 1014 is a floppy disk drive, the removable storage unit 1018 may be a floppy disk. In one embodiment, the removable storage unit 1018 may be non-transitory computer readable recording media.

In some embodiments, the secondary memory 1010 may include alternative means for allowing computer programs or other instructions to be loaded into the computer system 1000, for example, the removable storage unit 1022 and an interface 1020. Examples of such means may include a program cartridge and cartridge interface (e.g., as found in video game systems), a removable memory chip (e.g., EEPROM, PROM, etc.) and associated socket, and other removable storage units 1022 and interfaces 1020 as will be apparent to persons having skill in the relevant art.

The computer system 1000 may also include a communications interface 1024. The communications interface 1024 may be configured to allow software and data to be transferred between the computer system 1000 and external devices. Exemplary communications interfaces 1024 may include a modem, a network interface (e.g., an Ethernet card), a communications port, a PCMCIA slot and card, etc. Software and data transferred via the communications interface 1024 may be in the form of signals, which may be electronic, electromagnetic, optical, or other signals as will be apparent to persons having skill in the relevant art. The signals may travel via a communications path 1026, which may be configured to carry the signals and may be implemented using wire, cable, fiber optics, a phone line, a cellular phone link, a radio frequency link, etc.

Computer program medium and computer usable medium may refer to memories, such as the main memory 1008 and secondary memory 1010, which may be memory semiconductors (e.g. DRAMs, etc.). These computer program products may be means for providing software to the computer system 1000. Computer programs (e.g., computer control logic) may be stored in the main memory 1008 and/or the secondary memory 1010. Computer programs may also be received via the communications interface 1024. Such computer programs, when executed, may enable computer system 1000 to implement the present methods as discussed herein. In particular, the computer programs, when executed, may enable processor device 1004 to implement the methods illustrated by FIGS. 5-9, as discussed herein. Accordingly, such computer programs may represent controllers of the computer system 1000. Where the present disclosure is implemented using software, the software may be stored in a computer program product and loaded into the computer system 1000 using the removable storage drive 1014, interface 1020, and hard disk drive 1012, or communications interface 1024.

Techniques consistent with the present disclosure provide, among other features, systems and methods for the distribution of offers and offer profiles based on redemption history and the fulfilling of a request for profiles. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for distributing an offer to a consumer based on redemption history, comprising:
storing, in a consumer database, a plurality of consumer profiles, wherein each consumer profile is associated with a consumer and includes at least a consumer identifier and offer redemption data;
receiving, by a receiving device, a plurality of redeemed offers associated with a consumer identification, wherein the plurality of redeemed offers are associated with a plurality of offer categories;
identifying, by a processing device, a specified consumer profile, wherein the consumer identifier of the specified consumer profile corresponds to the consumer identification;
storing, in the offer redemption data of the specified consumer profile, the received plurality of redeemed offers;
generating, by the processing device, a behavioral profile for the specified consumer profile based on the corresponding offer redemption data, wherein the behavioral profile includes at least a propensity to redeem an offer for each offer category of the plurality of offer categories; and
transmitting, by a transmitting device, an offer to a consumer associated with the specified consumer profile, based on a specific offer category associated with the offer and the propensity to redeem an offer for the specific offer category of the consumer associated with the specified consumer profile.

2. The method of claim 1, wherein the plurality of offer categories includes at least one of: a particular merchant, a particular manufacturer, a transaction amount, an offer amount, a particular industry, an offer type, an offer quantity, and a length of availability.

3. The method of claim 1, wherein each consumer profile further includes a method of distribution, and wherein transmitting an offer to a consumer further comprises transmitting the offer to the consumer by the method of distribution included in the specified consumer profile.

4. The method of claim 1, wherein the offer transmitted to the consumer is associated with a propensity to redeem threshold, and wherein the propensity to redeem an offer for the specific offer category of the consumer exceeds the propensity to redeem threshold.

5. A method for distributing an offer profile based on redemption history, comprising:
storing, in a consumer database, a plurality of consumer profiles, wherein each consumer profile is associated with a consumer and includes at least a consumer identifier and offer redemption data, wherein the offer redemption data includes a plurality of offers redeemed by the associated consumer, the plurality of offers associated with a plurality of offer categories;
receiving, by a receiving device, a request for a behavioral profile, wherein the request for a behavioral profile includes at least a consumer identification and at least one offer category;
identifying, by a processing device, a specified consumer profile, wherein the consumer identifier of the specified consumer profile corresponds to the consumer identification;
generating, by the processing device, a behavioral profile for the specified consumer profile based on the corresponding offer redemption data, wherein the behavioral profile includes a propensity to redeem an offer for each offer category of the at least one offer category; and
transmitting, by a transmitting device, the generated behavioral profile in response to the request for a behavioral profile.

6. The method of claim 5, wherein the plurality of offer categories includes at least one of: a particular merchant, a particular manufacturer, a transaction amount, an offer amount, a particular industry, an offer type, an offer quantity, and a length of availability.

7. A method for fulfilling a request for behavioral profiles, comprising:
storing, in a consumer database, a plurality of consumer profiles, wherein each consumer profile is associated with a consumer and includes at least a consumer identifier and offer redemption data, wherein the offer redemption data includes a plurality of offers redeemed by the associated consumer, the plurality of offers associated with a plurality of offer categories;
receiving, by a receiving device, a request for behavioral profiles, wherein the request for behavioral profiles includes a specified offer category and a propensity to redeem threshold;
generating, by a processing device, a behavioral profile for each consumer profile of the plurality of consumer profiles based on the corresponding offer redemption data, wherein the behavioral profile includes at least a propensity to redeem an offer for the specified offer category;
identifying, by the processing device, at least one behavioral profile, wherein the included propensity to redeem an offer for the specified offer category exceeds the propensity to redeem threshold; and
transmitting, by a transmitting device, the identified at least one behavioral profile 310 in response to the request for behavioral profiles.

8. The method of claim 7, wherein the plurality of offer categories includes at least one of: a particular merchant, a particular manufacturer, a transaction amount, an offer amount, a particular industry, an offer type, an offer quantity, and a length of availability.

9. A system for distributing an offer to a consumer based on redemption history, comprising:
a consumer database configured to store a plurality of consumer profiles, wherein each consumer profile is associated with a consumer and includes at least a consumer identifier and offer redemption data;
a receiving device configured to receive a plurality of redeemed offers associated with a consumer identification, wherein the plurality of redeemed offers are associated with a plurality of offer categories;
a processing device configured to
identify a specified consumer profile, wherein the consumer identifier of the specified consumer profile corresponds to the consumer identification,
store, in the offer redemption data of the specified consumer profile, the plurality of redeemed offers, and
generate a behavioral profile for the specified consumer profile based on the corresponding offer redemption data, wherein the behavioral profile includes at least a propensity to redeem an offer for each category of the plurality of offer categories; and
a transmitting device configured to transmit an offer to a consumer associated with the specified consumer profile, based on a specific offer category associated with the offer and the propensity to redeem an offer for the specific offer category of the consumer associated with the specified consumer profile.

10. The system of claim 9, wherein the plurality of offer categories includes at least one of: a particular merchant, a particular manufacturer, a transaction amount, an offer amount, a particular industry, an offer type, an offer quantity, and a length of availability.

11. The system of claim 9, wherein each consumer profile further includes a method of distribution, and wherein transmitting an offer to a consumer further comprises transmitting the offer to the consumer by the method of distribution included in the specified consumer profile.

12. The system of claim 9, wherein the offer transmitted to the consumer is associated with a propensity to redeem threshold, and wherein the propensity to redeem an offer for the specific offer category of the consumer exceeds the propensity to redeem threshold.

13. A system for distributing an offer profile based on redemption history, comprising:
a consumer database configured to store a plurality of consumer profiles, wherein each consumer profile is associated with a consumer and includes at least a consumer identifier and offer redemption data, wherein the offer redemption data includes a plurality of offers redeemed by the associated consumer, the plurality of offers associated with a plurality of offer categories;
a receiving device configured to receive a request for a behavioral profile, wherein the request for a behavioral profile includes at least a consumer identification and at least one offer category;
a processing device configured to
identify a specified consumer profile, wherein the consumer identifier of the specified consumer profile corresponds to the consumer identification, and
generate a behavioral profile for the specified consumer profile based on the corresponding offer redemption data, wherein the behavioral profile includes a propensity to redeem an offer for each offer category of the at least one offer category; and
a transmitting device configured to transmit the generated behavioral profile in response to the request for a behavioral profile.

14. The system of claim 13, wherein the plurality of offer categories includes at least one of: a particular merchant, a particular manufacturer, a transaction amount, an offer amount, a particular industry, an offer type, an offer quantity, and a length of availability.

15. A system for fulfilling a request for behavioral profiles, comprising:
a consumer database configured to store a plurality of consumer profiles, wherein each consumer profile is associated with a consumer and includes at least a consumer identifier and offer redemption data, wherein the offer redemption data includes a plurality of offers redeemed by the associated consumer, the plurality of offers associated with a plurality of offer categories;
a receiving device configured to receive a request for behavioral profiles, wherein the request for behavioral profiles includes a specified offer category and a propensity to redeem threshold;
a processing device configured to
generate a behavioral profile for each consumer profile of the plurality of consumer profiles based on the corresponding offer redemption data, wherein the behavioral profile includes at least a propensity to redeem an offer for the specified offer category, and
identify at least one behavioral profile, wherein the included propensity to redeem an offer for the specified offer category exceeds the propensity to redeem threshold; and
a transmitting device configured to transmit the identified at least one behavioral profile in response to the request for behavioral profiles.

16. The system of claim 15, wherein the plurality of offer categories includes at least one of: a particular merchant, a particular manufacturer, a transaction amount, an offer amount, a particular industry, an offer type, an offer quantity, and a length of availability.
